(19) United States
(12) Patent Application Publication
(10) Pub. No.: US 2004/0000302 A1
(43) Pub. Date: Jan. 1, 2004

(54) Process for reproduction of images on a base material

(76) Inventors: Jae Gyu Kim, La Crescenta, CA (US); Jin Fang Liu, Yiwn (CN)

Correspondence Address: Eugene OAK, Ph. D., J. D.,, Patent Attorney, 610 S. Van Ness Ave., Los Angels, CA, 90005, US

(21) Appl. No.: 10/183,621

(22) Filed: Jun. 28, 2002

(51) Int. Cl. B28D 1/26

(52) U.S. Cl. 125/40

(57) ABSTRACT

A novel method enables a reproduction of, including but not limited to, portraits, drawings, images, photos, figures and phrases in multiple color on a slab of, including but not limited to, a bluestone, marble and granite which constitue base material. An enlarged image of the object to be reproduced is sketched on a slab of black colored bluestone of thickness between 0.1 to 10 cm and density of 2.5 to 3.5 g/cm³. A gimlet made of an alloy of, including but not limited to, copper, iron and nickel is used to peck the slab on which the image is sketched. Outline and shade of the image is controlled by the depth and width of the scratch pecked by the gimlet. Colors of the drawing are coated by brushing oil dyestuffs on the pecked surface followed by a wipe out process. The oil dyestuffs left on the concave pecked surface result in the residual color of the drawing, images, and the base material. Endurance of the color and images on the slab against, including but not limited to, wind, sun light and moisture is increased by the method of this invention.

The present invention relates to a novel method of reproducing an image on a base mateial such as a slab of blue stone.

### BACKGROUND OF THE INVENTION

1. Field of Invention

This invention relates to a novel method of reproducing durable image on a base material such as a slab of blue stone.

2. Description of the Prior Art

U.S. Pat. No. 2,671,978 to Brusetti, et. al illustrates a method of carving a design in bas-relief in stone by injecting high velocity abrasive materials such as sand to a mask, portions of which is removed, to permit application of the abrasive to the stone and thus wear or grind away these portions of the stone to present the design in the desired bas relief. This is not to reproduce a drawing or picture but another carving method.

U.S. Pat. No. 4,159,600 to Kaminski illustrates a method for reproducing images on a granite and marble. Kaminski's method consists in the steps of tracing onto the surface of a transparent acetate film the outlines of shaded areas of the original, placing the film on the surface of a first sheet of tough material that is capable of resisting the impingement of blasted sand and that is a member of a laminate which also comprises a transparent backing sheet adhered to the back of the backing sheet, removing the shaded areas from the tough sheet, cutting through the film and the laminate along the premeter of the original to separate the laminate from the first sheet, placing a second sheet of tough material that is larger in area than the original onto the surface of the stone, tracing the perimeter of the original onto the second sheet and removing the entire traced original area there from, dusting the area of the stone from which the entire traced original area has been removed, adhering the cut out laminate to the surface of the stone in the open area of the second sheet, sand blasting through all of the cutout areas of both of the sheets of tough material and removing the sheets from the stone.

Kaminski's art is too much sophisticated, impossible to control the darkness of the shade and density of the color.

### SUMMARY OF THE INVENTION

The purpose of this invention is to provide a novel method of reproducing, including but not limited to, portraits, drawings, images, photos, figures and phrases in multiple colors on a slab of, including but not limited to, a bluestone, marble and granite. An enlarged image of the object to be reproduced is sketched by a pencil drawing directly on a slab of black colored bluestone of thickness between 0.1 to 10 cm. A gimlet made of an alloy of, including but not limited to, copper, iron and nickel is used to peck the slab on which the image is sketched. Clearance of outline and darkness of the shade of the image is controlled by the depth and width of the scratch pecked by the gimlet. Colors of the drawing are coated by brushing oil dyestuffs on the pecked surface followed by a wipe out process. The oil dyestuffs left on the concave pecked surface consist of the residual color of the drawing. Durability of the color and images on the slab against, including but not limited to, wind, sun light and moisture is increased by the method of this invention.

### BRIEF DESCRIPTION OF FIGURES

FIG. 1 is an enlarged sketch of a photograph on a black colored blue stone and original photograph for reproducing the darkness of the shadow and density of the color.

FIG. 2-a is a schematic drawing of the gimlet of this invention.

FIG. 2-b is an enlarged drawing of the tip of the gimlet.

FIG. 3 is a cross sectional view of the slab of the blue stone on which the figure is reproduced by pecking the stone with the gimlet.

### DETAILED DESCRIPTION OF THE PREFERRED EMBODIMENTS

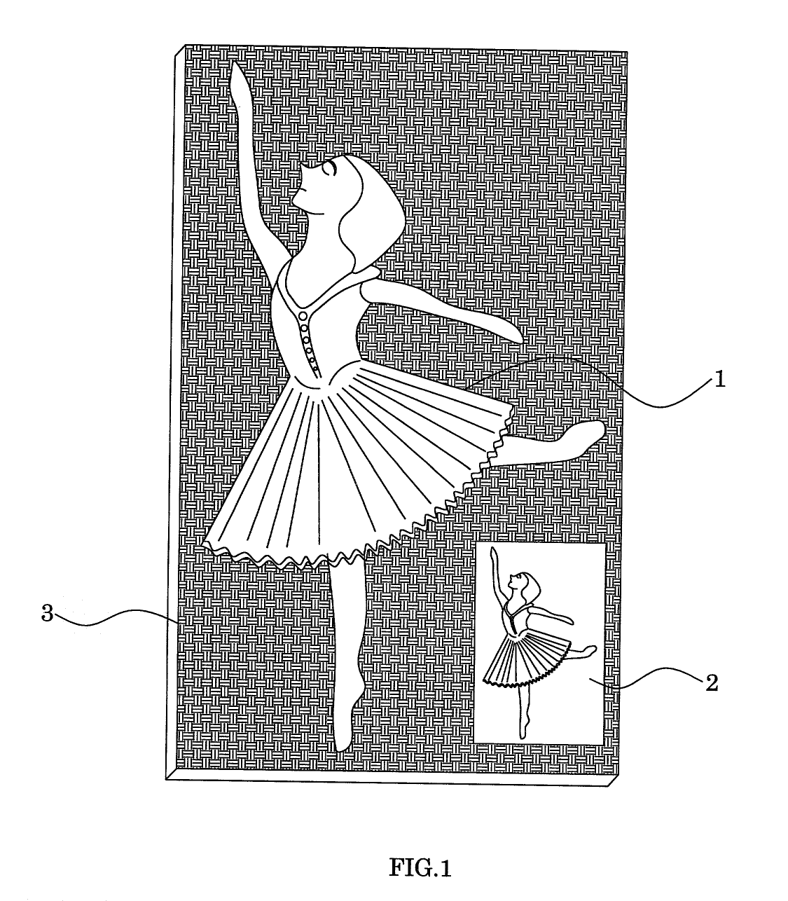

FIG. 1 is an enlarged sketch of a photograph on a black colored blue stone and original photograph for reproducing the darkness of the shadow and density of the color. An enlarged drawing (1) of the original picture (2) is sketched directly on the surface of a slab of thickness 5 to 10 mm bluestone (3) cut into desired size. The natural color of the smoothly ground surface of the blue stone is glossy black. When the surface is scratched, the scratched portion becomes light gray by the light scattering phenomena.

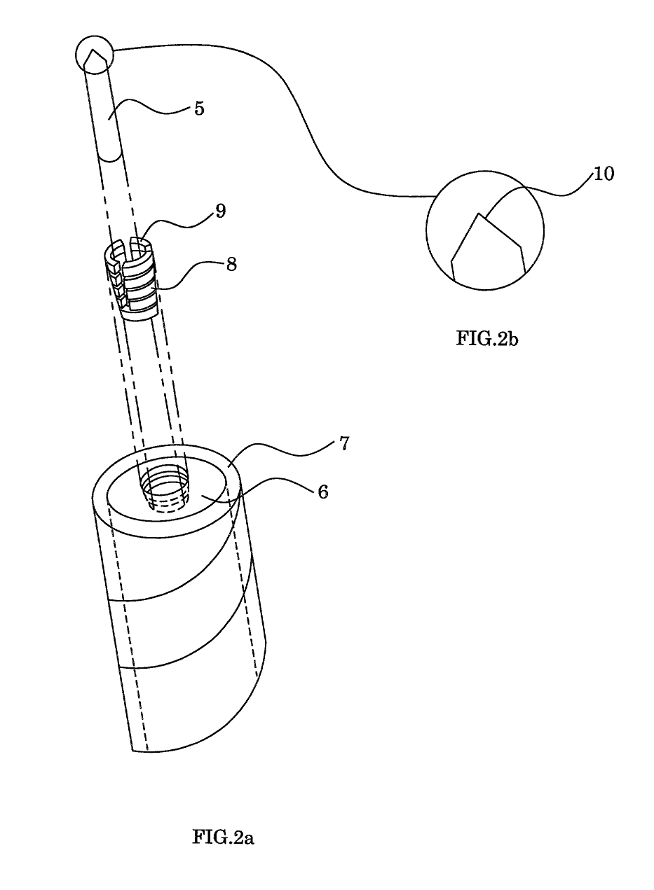

FIG. 2-a is a schematic drawing of the gimlet (4) of this invention. The tip (5) of the gimlet is made of, including but not limited to, highly tempered metal, tungsten carbide and industrial diamond. The handle (6) of the gimlet is weighted by mass of, including but not limited to, cast iron, stainless steel and lead. The surface (7) of the handle is covered by, including but not limited to, polyurethane, flexible PVC (polyvinyl chloride), silicone and leather. The tip (5) is fixed to the handle (6) by, including but not limited to, welding, screw (8) and clamp (9), which is made of brass, an alloy of copper, zinc and steel. FIG. 2-b is an enlarged drawing of the end (10) of the tip. The tip is 2 to 5 mm in thickness and at the end (10) the radius is sharply reduced to 0.1 mm within 4 mm of tip length. The tip end (10) is sharpened.

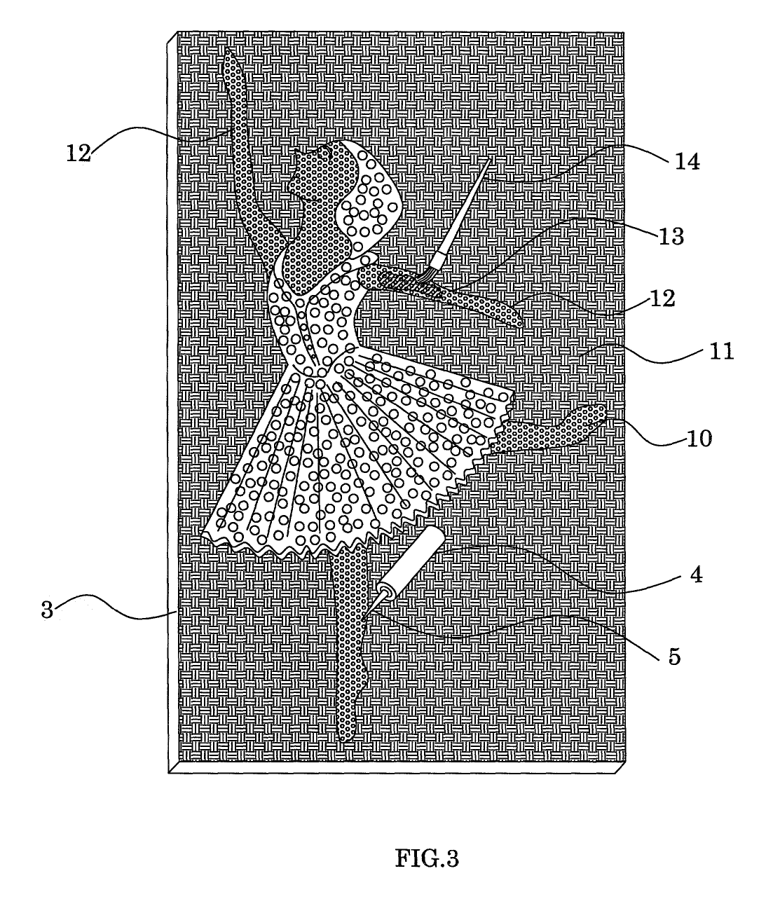

FIG. 3 is a perspective drawing of reproducing figures by pecking the bluestone slab. When a worker pecks the slab of blue stone (3) with the gimlet (4), the point pecked by the tip (5) becomes white. The denser the number of pecked points per area, the whiter the region becomes. Dark area (11) is formed by remaining it untouched and white area (12) is formed by pecking it densely. Oil color stuffs (13) are applied by a paint brush (14) on the pecked white area (12). The excess oil color stuffs are wiped out.

The best mode of this invention is to control the distance between peck points and cross sectional area of the tip end for control of the brightness of the shades.

What is claimed is:

1. A novel method and tool of reproducing portraits, drawings, images, photos, figures and phrases in multiple colors on a slab of a base material of a density of 2.5 to 3.5 g/cm³ by pecking the slab with a gimlet of hemi-sphere tip end, replaceably fixed to the handle by secrewd clamp made of an alloy of copper, iron and nickel, along the enlarged sketch of the object to be reproduced on a slab of black colored bluestone of thickness between 0.1 to 10 cm as needs.

2. Outline and shade of the images, portraits, drawings, photos, figures and phrases, in claim 1, is controlled by the depth, width of the pecked point and the space between the points pecked by the gimlet.

3. Color of the drawing, in claim 1, is impregnated in the concave surfaces by brushing oil dyestuffs on the pecked surface followed by a wipe out process.

4. The tip end, in claim 1, is made of highly tempered steel.

5. The tip end, in claim 1, is made of tungsten carbide.

6. The tip end, in claim 1, is made of industrial diamond.

7. The end of the tip of the gimlet, in claim 1, is sharpened as radius in the range of 0.01 to 0.2 mm.

8. Content of copper in the alloy, in claim 1, is in the range of 5 to 95%.

9. Content of nickel in the alloy, in claim 1, is in the range of 5 to 95%.

10. Content of iron in the alloy, in claim 1, is in the range of 5 to 95%.

11. The weight of the gimlet, in claim 1, is in the range of 100 to 1,000 g.
